(19) United States
(12) Patent Application Publication
(10) Pub. No.: US 2006/0014097 A1
(43) Pub. Date: Jan. 19, 2006

(54) Charge transport layer processing

(75) Inventors: Philip G. Perry, Webster, NY (US); Mark S. Thomas, Williamson, NY (US); Cindy C. Chen, Rochester, NY (US); Lanhui Zhang, Webster, NY (US); Man Kit Yip, Webster, NY (US); Linnette Perales Rivera, Webster, NY (US); April M. Mattox, Webster, NY (US); Kenneth Charles Gottschalk, West Henrietta, NY (US); Petrus Theodorus de Saegher, Venray (NL); Robert W. Hedrick, Spencerport, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/890,249

(22) Filed: Jul. 14, 2004

(51) Int. Cl. G03G 5/047

(52) U.S. Cl. 430/133; 430/135; 430/58.05

(57) ABSTRACT

This invention is generally directed to charge transport layers and charge transport layer formulations comprising polytetrafluoroethylene particles. This invention is also generally directed to methods of forming charge transport layers on electrophotographic imaging members. The inventive methods of forming charge transport layers provide a stable dispersion of polytetrafluoroethylene.

### BACKGROUND OF THE INVENTION

1. Field of Invention

This invention is generally directed to charge transport layers and charge transport layer formulations comprising polytetrafluoroethylene particles. This invention is also generally directed to methods of forming charge transport layers on electrophotographic imaging members. The inventive methods of forming charge transport layers provide a stable dispersion of polytetrafluoroethylene.

2. Description of Related Art

In the art of electrophotography, an electrophotographic imaging member comprising a photoconductive insulating layer on a conductive layer is imaged by first uniformly electrostatically charging the surface of the photoconductive insulating layer. The imaging member is then exposed to a pattern of activating electromagnetic radiation, such as light, which selectively dissipates the charge in the illuminated areas of the photoconductive insulating layer while leaving behind an electrostatic latent image in the non-illuminated areas. The electrostatic latent image is then developed to form a visible image by depositing toner particles on the surface of the photoconductive insulating layer. The resulting visible toner image is then transferred to a suitable recording medium, such as paper.

Electrophotographic imaging members are usually multilayered photoreceptors comprising a substrate, an optional hole blocking layer, an optional adhesive layer, a charge generating layer, and a charge transport layer (CTL). The photoreceptor can take several forms, including flexible belts, rigid drums, etc. When the photoreceptor is in the form of a flexible belt, often, an anti-curl layer is employed on the back side of the substrate, opposite to the side carrying the charge layers, to achieve the desired photoreceptor flatness and/or abrasion resistance.

Conventionally, charge transport layers contain several types of polymeric binders having charge transport material dispersed therein. However, conventional charge transport layers suffer from an extremely fast wear rate, particularly when the photoreceptor is charged using a bias charging roll (BCR), which is often used to form images at low speed, e.g., up to about 40 ppm, in imaging devices, such as copiers and printers. CTL wear results in a considerable reduction in the sensitivity of the imaging device and limits the life of the photoreceptor. Therefore, it is desirable to reduce the wear rate of the CTL, and thus the photoreceptor, particularly with respect to small diameter organic photoreceptor drums, as typically used in low speed copiers and printers that are charged with a BCR.

Known methods of reducing photoreceptor wear rate employ small particles, such as polytetrafluoroethylene (PTFE) particles, in the outer layers (including CTL) of the photoreceptor to reduce the coefficient of friction thereby increasing the durability of the outer layers and enabling easier toner removal However, PTFE particles are difficult to disperse uniformly in the material, particularly the solvent, used in the specific outer layer, CTL, of the photoreceptor. When a CTL is formed using poorly dispersed PTFE particles, the photoreceptor exhibits reduced electrical performance due to high residual voltage (Vr) and Vr cycle-up, and exhibits poor print quality due to the presence of large size particle aggregates, which can cause white spots to appear in a solid image area. In addition, the filter generally used during CTL formation becomes plugged when PTFE particles agglomerate, which results in PTFE loading errors.

Moreover, PTFE particles slowly settle over time in a CTL dispersion as a result of the high density of the particles. Thus, it is necessary to frequently stir the dispersion to avoid settling. This is an impractical method for maintaining the uniformity of the dispersion over time, and renders storage and shipment of the dispersion difficult.

Therefore, it would be desirable to form a charge transport layer on a photoreceptor, or other imaging member, having a highly stable PTFE dispersion, which increases the durability of the outer layers of the photoreceptor, while avoiding the problems associated with PTFE particles in known CTL formulations.

### SUMMARY OF THE INVENTION

It is an embodiment of the invention to develop methods of forming charge transport layers comprising PTFE particles dispersed therein having reduced or non-existent particle agglomeration. 10009] It is also an embodiment of the invention to form charge transport layers that reduce the wear rate of the imaging member, e.g., photoreceptor, and thus improve the imaging member durability, provide excellent electrical performance and superior print quality, and improve toner removal capabilities and plywood suppression (a print artifact).

It is also an embodiment of the invention to form charge transport layers that possess wear resistance and durability.

It is also an embodiment of the invention to form stable charge transport layer formulations, comprising: combining PTFE particles, at least one surfactant, and at least one solvent to form a slurry; separately combining at least one polycarbonate polymeric binder, at least one charge transport material, preferably at least one antioxidant, and at least one solvent to form a base composition; and mixing the slurry and base composition to form a stabilized PTFE dispersion, wherein the PTFE particles are uniformly dispersed. The order in which the components of the CTL formulation are combined provides surprisingly improved long term stability in terms of wear resistance and durability, for example, to the CTL.

In a preferred embodiment of the invention, CTL formulation formation comprises combining PTFE particles with at least one polycarbonate binder, at least one charge transport material, at least one surfactant, and at least one solvent, such that the PTFE particles are uniformly dispersed and have a volume average size of less than about 3.0 microns, more preferably, less than about 1.5 microns.

Another embodiment of the invention is directed to CTL formulations comprising: at least one polycarbonate polymeric binder, at least one charge transport material, preferably at least one antioxidant, a solvent system comprising tetrahydrofuran and an aromatic hydrocarbon, uniformly dispersed PTFE particles, and at least one surfactant.

In a preferred embodiment of the invention, the CTL formulations comprise at least one polycarbonate polymeric binder having an average molecular weight of not less than about 35,000 Mw, at least one charge transport material, uniformly dispersed PTFE particles having a volume average size of less than about 3.0 microns, more preferably, less than about 1.5 microns, at least one fluorinated polymeric surfactant, and a solvent mixture comprising tetrahydrofuran (THF) and an aromatic hydrocarbon, such as, for example, toluene.

Another embodiment of the invention is directed to image forming devices comprising a photoreceptor and an AC bias charging roll, which contacts and charges the photoreceptor, wherein the photoreceptor comprises: a substrate, a charge generating layer, a charge transport layer, an optional anti-curl layer, an optional hole blocking layer, an optional adhesive layer, and an optional overcoat layer, wherein the charge transport layer comprises at least one polycarbonate polymeric binder, at least one charge transport material, preferably at least one antioxidant, a solvent system comprising tetrahydrofuran and an aromatic hydrocarbon, uniformly sized and dispersed PTFE particles, and at least one surfactant.

In a preferred embodiment of the invention, the image forming devices comprise a photoreceptor and a bias charging roll, which contacts and charges the photoreceptor, wherein the photoreceptor comprises: an optional anti-curl layer; a substrate; an optional hole blocking layer; an optional adhesive layer; an optional overcoat layer; a charge generating layer; and a charge transport layer comprising a polycarbonate polymeric binder having an average molecular weight of not less than about 35,000 Mw, a charge transport material, uniformly dispersed PTFE particles having a volume average size of less than about 3.0 microns, more preferably, less than about 1.5 microns, a fluorinated polymeric surfactant, an antioxidant, and a solvent system comprising at least two solvents.

Another embodiment of the invention is directed to methods for forming stable charge transport layers, comprising: combining PTFE particles, at least one surfactant, and at least one solvent to form a slurry; separately combining at least one polycarbonate polymeric binder, at least one charge transport material, preferably at least one antioxidant, and at least one solvent to form a base composition; mixing the slurry and base composition to form a stabilized PTFE dispersion, wherein the PTFE particles are uniformly dispersed; and coating a photoreceptor surface with the stabilized PTFE dispersion.

### DETAILED DESCRIPTION OF PREFERRED EMBODIMENTS

In an embodiment of the present invention, an imaging member, such as, for example, a photoreceptor, comprises a charge transport layer, which comprises at least one polycarbonate binder, at least one charge transport material, PTFE particles having a volume average size of less than about 3.0 microns, more preferably, less than about 1.5 microns, preferably at least one antioxidant, and at least two solvents.

Polycarbonate Binder

Although it has been difficult to form uniform and stable CTL dispersions with high molecular weight polycarbonates, such is surprisingly achieved in the present invention. The high molecular weight polycarbonate binders contribute to the durability and wear resistance of the charge transport layer.

The polycarbonate binder preferably has an average molecular weight of not less than about 35,000 Mw, although lower weight polycarbonates may be used, if desired. Preferably, the polycarbonate binder is polymeric and comprises a polycarbonate Z polymer(bisphenol Z-type polycarbonate polymer). More preferably, the polycarbonate Z polymer is a poly(4,4′-diphenyl-1,1′-cyclohexane carbonate)polymer having the following structure, wherein “n” is appropriate for the particular molecular weight:

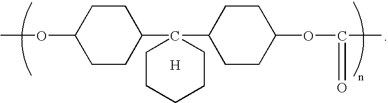

An example of this type of polycarbonate binder is the commercially available PCZ-400 or lupilon® Z400 (Mitsubishi Gas Chemical Co., Tokyo, Japan).

The final charge transport layer preferably contains between about 25 to about 75% by weight of the binder based on the total weight of the charge transport layer, more preferably, about 35 to about 65% by weight and, most preferably, about 40 to about 60% by weight.

Charge Transport Material

Charge transport layers are preferably capable of supporting the injection of photogenerated holes and electrons from the charge generating layer and also, be capable of allowing the transport of these holes or electrons to selectively discharge the surface charge. Thus, the charge transport layer formulation includes at least one charge transport material. Any suitable charge transport material known in the art may be used, preferably dispersed within, or incorporated into the chain of, the polycarbonate binder.

Suitable charge transport materials are well known in the art and selection would be well-within the purview of one of ordinary skill in the art. Preferably, the charge transport material comprises an aromatic amine compound. More preferably, the charge transport layer comprises an arylamine-based small molecule dissolved, or molecularly dispersed, in the polycarbonate binder. Typical aromatic amine compounds include, but are not limited to, triphenylamines, bis and poly triarylamines, bis arylamine ethers, bis alkylarylamines, and the like. Most preferably, the charge transporting material is an aromatic amine, such as, for example, m-TBD (N,N′-diphenyl-N,N′-bis(3-methylphenyl)-1,1′-biphenyl-4,4′-diamine), which has the following formula:

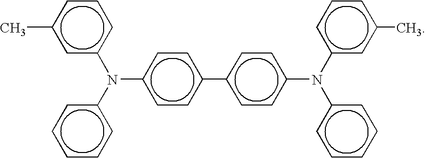

Alternative preferable charge transport materials include, but are not limited to, the aromatic amine N,N-bis(3,4-dimethylphenyl)biphenyl-4-amine, such as, for example, the commercially avialable AE-18 (Sankio Chemical Co., Ltd., Tokyo, Japan), which has the following formula:

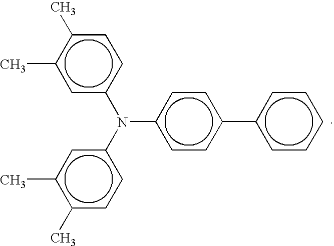

The final charge transport layer preferably contains between about 5.0 to about 60% by weight of the charge transport material based on the total weight of the charge transport layer, more preferably, about 10 to about 55% by weight, and, most preferably, about 15 to about 45% or about 40% by weight.

PTFE Particles

To increase wear resistance of the charge transport layer, and thus the photoreceptor or other imaging device, PTFE particles are included in the charge transport layer formulation. Any commercially available PTFE particles may be employed including, but not limited to, the commercially available Teflon® (E.I. DuPont de Nemours & Co., Wilmington, Del.) and Lubron L-2 (Daikin America, Inc., Decatur, Ala.).

The PTFE particles are preferably included in a concentration of about 0.5 to about 20% by weight of the charge transport layer, more preferably, about 2.5 to about 10% by weight, and, most preferably, about 7.0 to about 9.0% by weight.

Surfactant

As described above, the incorporation of PTFE in previous CTL formulations caused non-uniform coating and other problems associated with the PTFE settlement and particle aggregation. To reduce such problems, in the inventive methods and compositions, the PTFE particles are incorporated in the CTL formulation with a surfactant, such that the PTFE particles are stabilized by the surfactant during mixing, and thus are more uniformly sized and dispersed within the CTL.

Preferably, the surfactant is a fluorinated polymeric surfactant. More preferably, the fluorinated polymeric surfactant is a fluorinated graft copolymer, such as, for example, poly(fluoroacrylate derivative)-graft-poly(methylmethacrylate derivative), commercially available as, for example, GF-300 (Daikin America, Inc.). However, any suitable fluorinated polymeric surfactant known in the art as described in U.S. Pat. No. 5,637,142, for example, incorporated by reference herein in its entirety, may be used.

The surfactant is preferably present in a concentration of about 0.05 to about 1.0% by weight of the charge transport layer, more preferably, about 0.1 to about 0.3% by weight, and, most preferably, about 0.15 to about 0. 18% by weight. However, the optimum concentration of surfactant depends on the concentration of PTFE such that if the PTFE concentration is increased, then the surfactant concentration is proportionally increased. Preferably, the surfactant to PTFE weight ratio is from about 1:200 to about 1:5. The most preferred ratio is from about 1:100 to about 1:20.

Solvent

The CTL formulation further generally comprises a solvent system comprising at least two solvents, which are preferably non-halogenated, to assist in obtaining a stable dispersion of the CTL components. Any suitable solvent known in the art, or mixtures of such solvents, may be used in the CTL formulation provided that at least one of the solvents has a boiling temperature of about 70° C. or less and at least one of the solvents has a boiling temperature of about 93° C. or more. Preferably, the solvent system components complement one another such that if one solvent component has a rapid evaporation rate that is too fast to be effective as a CTL solvent, for example, then the second solvent component has a slower evaporation rate that counteracts the rapid evaporation rate of the first solvent component. Solvents are preferably selected to avoid competition with the surfactant to bind or cover the surface of the PTFE particles.

Preferred solvents include, but are not limited to, ethers, such as, for example, tetrahydrofuran (THF), combined with aromatic hydrocarbons, such as, for example, toluene, xylene, monochlorobenzene, catechol, hydroquinone, or cyclohexanone. More preferably, the solvent system comprises THF and toluene. The preferred weight ratio of the first solvent, such as, for example, THF, to the second solvent, such as, for example the aromatic hydrocarbon toluene, is from about 100:0 to about 50:50, more preferably, from about 90:10 to about 70:30, and most preferably, about 75:25.

The lower boiling temperature solvent, such as, for example, THF, is preferably included in a concentration of about 60 to about 100% by weight of the solvent component of the charge transport layer, more preferably, about 69 to about 77% by weight, and, most preferably, about 70 to about 75% by weight. The higher boiling temperature solvent, such as, for example, the aromatic hydrocarbon toluene, is preferably included in a concentration of about 0 to about 40% by weight of the solvent component of the charge transport layer, more preferably, about 23 to about 31% by weight, and, most preferably, about 25 to about 30% by weight.

Antioxidant

Another component of the CTL formulation may be at least one antioxidant, such as, for example, butylhydroxytoluene (BHT) (2,6-di-tert-butyl-4-methylphenol) at a concentration of about 0.2 to about 5.0% by weight of the charge transport layer, more preferably, about 0.4 to about 3.0% by weight, and, most preferably, about 0.9 to about 2.8% by weight.

Other possible antioxidants, at the recited concentrations, include, but are not limited to, pentaerythritol Tetrakis(3-(3,5-di-tert-butyl-4-hydroxyphenyl)propionate); 6,6′-di-tert-butyl-2,2′-thiodi-p-cresol; octadecyl-3-(3,5-di-tert-butyl-4-hydroxyphenyl)propionate; calciumdiethyl bis(((3,5-bis(1,1-dimethylethyl)-4-hydroxyphenyl)methyl)phosphonate); 1,3,5-tris(3,5-di-tert-butyl-4-hydroxybenzyl)-1,3,5-triazine-2,4,6-(1H,3H,5H)-trione; 1,3,5-tris(4-tert-butyl-3-hydroxy-2,6-dimethylbenzyl)-1,3,5-triazine-2,4,6-(1H,3H,5H)-trione; 2,6-di-tert-butyl-4-(4,6-bis(octylthio)-1,3,5-triazin-2-ylamino)phenol; and 2,2′-methylenebis(4-ethyl-6-tert-butylphenol), such as, for example, the commercially available (Irganox® from Ciba Specialty Chemicals Corp., Tarrytown, N.Y.) Irganox® 1010, Irganox® 1081, Irganox® 1076, Irganox® 1425, Irganox® 3114, Irganox® 3790, Irganox® 565, and Cyanox® 425 (Cytec Technology Corp., Wilmington, Del.), respectively, having the respective formulae: 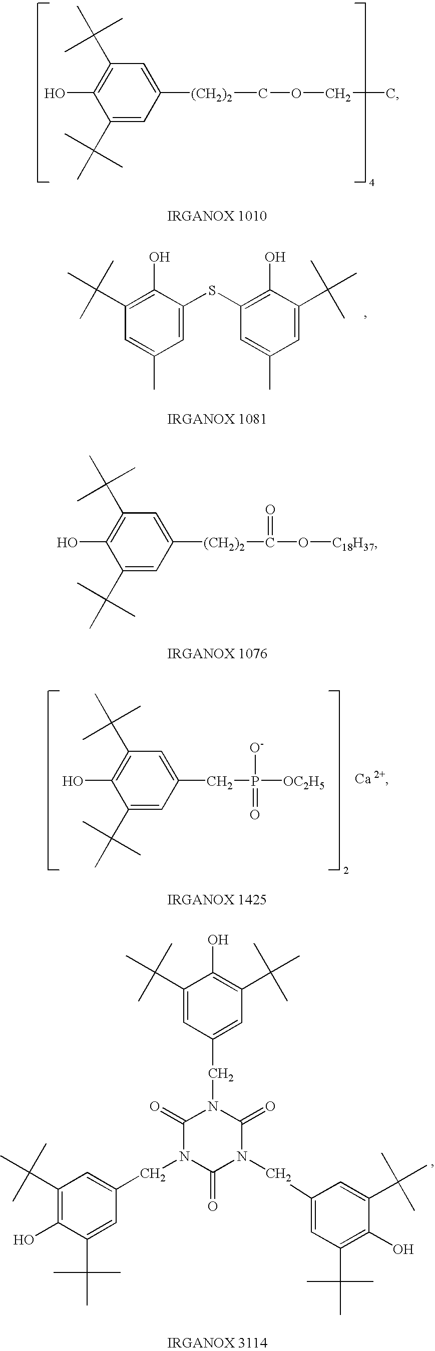 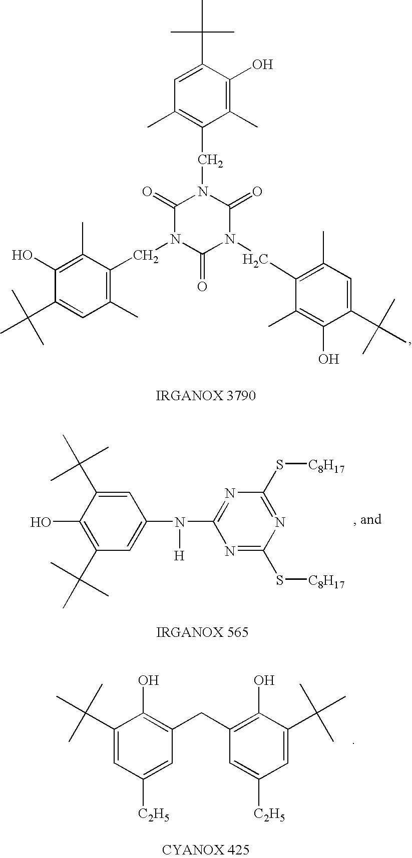
Additional Components

Additional components may be included in the CTL formulation as needed or desired, such as, for example, leveling agents, which prevent, or at least reduce, the occurrence of the “orange peel effect.” Preferred leveling agents include, but are not limited to, silicone coating additives, such as, for example, silicone oils alone or premixed with other solvents, such as, for example, toluene, in a concentration of about 0 to about 10% by weight of the charge transport layer, more preferably, about 0.001 to about 1% by weight, and, most preferably, about 0.001 to about 0.010% by weight. Suitable leveling agents are known in the art and include, but are not limited to, the commercially available KP-340 (ShinEtsu Chemical Co., Ltd., Tokyo, Japan).

Formation of the Charge Transport Layer

The final charge transport layer preferably possesses a BCR wear rate of less than about 6 microns per 100 kilocycles, which is about half that of conventional charge transport layers (which exhibit a BCR wear rate of about 8 to about 9 microns per 100 kilocycles).

Various inventive methods may be used to prepare the CTL formulations, and resulting charge transport layers, preferably having the improved BCR wear rate. The methods require specific combinations of CTL formulation components added to suitable mixing vessels, such as, for example, a carboy, to obtain uniformly sized and dispersed PTFE particles in the CTL.

In one preferred method, a PTFE slurry is prepared and added to a mixture of CTL “base” components. In this method, the PTFE particles are stabilized by the surfactant in the slurry formation step. As such, the PTFE particles are less likely to agglomerate with adjacent particles, and thus can be maintained at the desired uniform size resulting in a stable PTFE dispersion and improved CTL. The method described below recites the preparation of the PTFE slurry prior to the preparation of the CTL base. However, the CTL base may be prepared before the PTFE slurry is prepared.

In a preferred embodiment, the PTFE slurry may be prepared by a method comprising: weighing the first solvent component and adding it to a mixing vessel; optionally weighing a portion of the polycarbonate polymeric binder and adding it to the mixing vessel to prevent agglomeration of the PTFE particles by increasing the viscosity of the PTFE slurry; weighing the surfactant and adding it to the mixing vessel to obtain the slurry base; weighing the PTFE particles and adding them to the slurry base (about 2 to about 20% loading) to obtain the PTFE slurry; and processing the PTFE slurry using a homogenizer, or similarly functioning device, at, for example, about 1000 to about 15,000 psi, preferably, about 5000 to about 7500 psi, provided that the temperature does not rise above about 50° C., using, for example, a “14/20” cavitating element configuration, or any suitable configuration depending on the desired end result and the requirements of the homogenizer or similarly functioning device.

Homogenization may be carried out using any conventional homogenizer including, but not limited to, cavitation devices, such as, for example, the commercially available CaviPro® (CP500) (Five Star Technologies, Cleveland, Ohio), and sonication devices, such as, for example, the commercially available VirSonic 550, wherein preferred conditions include, but are not limited to, about 20% intensity, with an about ½ inch probe, using an about 30 cc sample, and running for about 3 minutes.

In a separate suitable mixing vessel, the CTL base components including, for example, the second solvent component, the complete or remaining (if a portion is added to the PTFE slurry preparation) polycarbonate polymeric binder, antioxidant, charge transport material, and optional leveling agent are each weighed, added to the mixing vessel, and combined. The combined PTFE slurry components are added to the CTL base and mixed well.

The base and slurry formulation may be stirred at a temperature ranging from about 10° C. to about 30° C., for a sufficient time, such as, for example, at least about 4 to about 24 hours to form a stable PTFE dispersion.

Homogenizing the PTFE at its final loading with nearly all of the necessary solvent and then adding the remaining CTL materials as mostly dry material such that they dissolve in the PTFE slurry helps reduce the possibility of reagglomeration of the PTFE particles after processing, which can cause poor coating surface quality and filtration problems.

Alternatively, the CTL formulation can be prepared by a multi-step method comprising: preparing a first part of the CTL base, preparing a second part of the CTL base, preparing the PTFE slurry, processing the PTFE slurry, and blending the processed PTFE slurry with the CTL base. The order of individual CTL base and PTFE slurry preparations may vary and is not critical, provided that the base and slurry are prepared separately as described below. In addition, the CTL base preparation steps may be combined into one step.

More specifically, in the first step, preparing a first part of the CTL base, a preferred method comprises:

(a) weighing the first solvent component and adding it to a mixing vessel;

(b) weighing the second solvent component and adding it to the mixing vessel

(c) weighing the polycarbonate polymeric binder and adding it to the mixing vessel; and

(d) mixing the ingredients for about 1 to about 3 hour(s), preferably, about two hours, until the material is totally dissolved.

In the second step, preparing a second part of the CTL base, a preferred method comprises:

(e) weighing the charge transporting material and adding it to the mixing vessel;

(f) weighing a second charge transporting material, if any, and adding it to the mixing vessel;

(g) weighing the leveling agent, if any, and adding it to the mixing vessel;

(h) weighing the antioxidant and adding it to the mixing vessel; and

(i) mixing the ingredients for about 4 to about 24 hour(s), preferably, about twelve hours, until the material is totally dissolved.

Third, a preferred method for preparing the slurry base comprises:

(a) weighing the first solvent component and adding it to a separate mixing vessel;

(b) weighing the polycarbonate polymeric binder and adding it to the separate mixing vessel;

(c) weighing the surfactant and adding it to the separate mixing vessel; and

(d) blending/rolling the components together for about 1 to about 24 hour(s), preferably, about one hour, to ensure mixing and dissolving.

Fourth, a preferred method for processing the PTFE slurry comprises:

(e) weighing the PTFE particles and adding them to the slurry base (about 20% loading);

(f) blending/rolling the slurry components for about 1 to about 24 hour(s), preferably, about one hour, to ensure mixing; and

(g) processing the PTFE slurry with a homogenizer, or similarly functioning device, at, for example, about 1000 to about 15,000 psi, preferably, about 5000 to about 7500 psi, provided that the temperature does not rise above about 50° C., using, for example, a “14/20” cavitating element configuration or any suitable configuration depending on the desired end result and the requirements of homogenizer or similarly functioning device, for at least two discrete passes.

Fifth, a preferred method for blending the PTFE slurry with the CTL base, comprises:

(a) adding the PTFE slurry to the CTL base to obtain a final loading of about 2% (with solvent);

(b) mixing the ingredients for about 1 to about 4 hour(s), preferably, about two hours, until well blended; and

(c) blending/rolling the mixture with a homogenizer, or similarly functioning device, at about 1000 to about 15,000 psi, preferably, about 5000 to about 7500 psi, provided that the temperature does not rise above about 50° C., for example, using a “14/20” cavitating element configuration or any suitable configuration depending on the desired end result and the requirements of the homogenizer or similarly functioning device, for at least one discrete pass.

Charge Transport Layer

The charge transport layer dispersion can be applied to an imaging member, preferably, a photoreceptor, as a layer using any suitable technique including, but not limited to, spraying, dip coating, roll coating, wire wound rod coating, draw bar coating, and the like. The preferred final charge transport layer thickness is between about 15 to about 45 microns. The life of a photoreceptor is considered to theoretically end when the charge transport layer is worn down to a thickness of about 12 microns.

Photoreceptors

Photoreceptors of the invention employing a charge transport layer formulated using at least one of the inventive methods generally comprise, in addition to the inventively formed charge transport layer, a substrate and a charge generating layer. Optional layers include, but are not limited to, a hole blocking layer, adhesive layer, overcoat layer, and anti-curl layer.

The charge generating layer and charge transport layer, as well as other layers, may be applied in any suitable order to produce either positive or negative charging photoreceptors. For example, the charge generating layer may be applied prior to the charge transport layer, as illustrated in U.S. Pat. No. 4,265,990, or the charge transport layer may be applied prior to the charge generating layer, as illustrated in U.S. Pat. No. 4,346,158, the entire disclosures of which are incorporated herein by reference in their entireties. Preferably, the charge transport layer is formed on the charge generating layer and the charge transport layer is optionally covered with an overcoat layer.

The photoreceptor substrate comprises any suitable organic or inorganic material having desired mechanical properties and may be opaque or substantially transparent. The substrate may be formed entirely or in part with a suitable electrically conductive material or an insulating material having an electrically conductive surface. The conductive surface, if present, may vary in thickness over a substantially wide range, depending on the desired use, and can be coated onto the substrate by any suitable coating technique, such as, for example, vacuum deposition or the like.

A hole blocking layer may optionally be added to the substrate. Generally, electron blocking layers for positively charged photoreceptors allow the photogenerated holes in the charge generating layer at the top of the photoreceptor to migrate toward the charge (hole) transport layer below and reach the bottom conductive layer during the electrophotographic imaging process. Thus, an electron blocking layer is normally not expected to block holes in positively charged photoreceptors, such as, for example, photoreceptors coated with a charge generating layer over a charge (hole) transport layer. For negatively charged photoreceptors, any suitable hole blocking layer capable of forming an electronic barrier to holes between the adjacent photoconductive layer and the underlying layer may be used. A hole blocking layer may comprise any suitable material and be applied by any suitable technique including, but not limited to, spraying, dip coating, draw bar coating, gravure coating, silk screening, air knife coating, reverse roll coating, vacuum deposition, chemical treatment, and the like.

An adhesive layer may optionally be added to the hole blocking layer. The adhesive layer may comprise any suitable film-forming polymer, such as, for example, polyester resins, polyacrylates, polyurethanes, or mixtures thereof. Any suitable technique may be used to apply the adhesive layer including, but not limited to, extrusion coating, gravure coating, spray coating, wire wound bar coating, and the like. The adhesive layer is generally applied directly to the hole blocking layer. Thus, the adhesive layer is generally in direct, contiguous contact with both the underlying hole blocking layer and the usually overlying charge generating layer to enhance adhesion, for example.

The charge generating layer may comprise single or multiple layers comprising inorganic or organic compositions or mixtures thereof. More specifically, the charge generating layer of the photoreceptor may comprise any suitable photoconductive particles dispersed in a film-forming binder as known in the art. Typical photoconductive particles include, but are not limited to, phthalocyanines, perylenes, trigonal selenium, quinacridones, substituted 2,4-diamino-triazines, polynuclear aromatic quinones, and the like. Exemplary binders for the photoconductive materials include, but are not limited to, thermoplastic and thermosetting resins as are well known in the art.

The charge generating layer may be applied to underlying layers by any suitable method known in the art. Typical application techniques include, but are not limited to, spraying, dip coating, roll coating, wire wound rod coating, and the like, followed by typical drying techniques, such as, for example, oven drying, infra red radiation drying, air drying, and the like.

Optionally, an overcoat layer may be added to improve resistance of the photoreceptor to abrasion. In some cases, an anti-curl coating may be applied to the surface of the substrate opposite to the surface bearing the charge transport layer to provide flatness and/or abrasion resistance. Overcoat and anti-curl coating layers are well known in the art. Generally, these layers comprise thermoplastic, organic polymers or inorganic polymers that are electrically insulating or slightly semiconductive.

The photoreceptors of the invention may be used in an electrophotographic image forming device for use in an electrophotographic imaging process. As described above, such image formation involves first uniformly electrostatically charging a photoreceptor and then exposing the charged photoreceptor to a pattern of activating electromagnetic radiation, such as, for example, light, which selectively dissipates the charge in the illuminated areas of the photoreceptor while leaving behind an electrostatic latent image in the non-illuminated areas. The electrostatic latent image may then be developed to form a visible image by depositing toner particles onto the surface of the photoreceptor. The resulting visible toner image can then be transferred to a suitable recording medium, such as, for example, paper. The photoreceptor may be charged using any well known method in the art, such as, for example, an AC bias charging roll or a corotron, dicorotron, or scorotron charging device. The various photoreceptor layers and methods of generating photoreceptors are described in, for example, U.S. Pat. No. 6,326,111, incorporated by reference herein in its entirety.

The invention will now be described in detail with respect to specific examples thereof All parts and percentages are by weight unless otherwise indicated.

### EXAMPLE

A CTL dispersion was prepared following the method set forth in Scheme 1 below. The results for the PTFE slurry were: initial stage: 644±14 nm; and one week: 630±13 nm, which indicate that the dispersion was very stable. The stability of the PTFE slurry was monitored by measuring its particle size distribution.

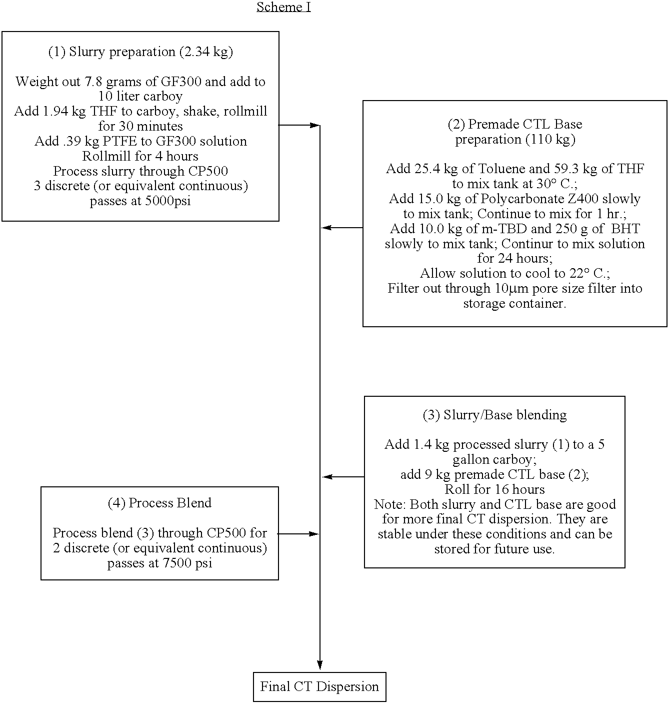

The PTFE particles were dispersed in THF in the presence of the sufactant GF-300 at about 2.0% by weight of total PTFE. The particle size distribution of the PTFE slurry (380 nm (92%), 1534 nm (8%)) was stable for up several months.

In contrast, the slurry prepared in a conventional mixed solvent system (THF:TOL=70:30) was not stable and its particle size continued to grow as measured by particle size measurement.

Although the invention has been described with reference to specific preferred embodiments, it is not intended to be limited thereto. Rather, those having ordinary skill in the art will recognize that variations and modifications may be made therein which are within the spirit of the invention and within the scope of the claims.

What is claimed is:

1. A method for forming a stable charge transport layer dispersion, comprising:
combining polytetrafluoroethylene (PTFE) particles, at least one surfactant, and at least one solvent to form a slurry;
separately combining at least one polycarbonate polymeric binder, at least one charge transport material, and at least one solvent to form a base composition; and
mixing the slurry and base composition to form a stabilized dispersion, wherein the PTFE particles are uniformly dispersed.

2. The method according to claim 1, wherein at least one polycarbonate polymeric binder is added to the slurry.

3. The method according to claim 1, wherein the base composition further comprises a leveling agent.

4. The method according to claim 1, wherein the surfactant is a fluorinated polymeric surfactant.

5. The method according to claim 4, wherein the fluorinated polymeric surfactant is a fluorine graft copolymer.

6. The method according to claim 1, wherein the at least one solvent in the slurry is tetrahydrofuran.

7. The method according to claim 1, wherein the at least one solvent in the base composition is an aromatic hydrocarbon.

8. The method according to claim 7, wherein the aromatic hydrocarbon is toluene.

9. The method according to claim 1, wherein the PTFE particles have a volume average size of less than about 1.5 microns.

10. The method according to claim 1, wherein the base composition further comprises at least one antioxidant.

11. A method for forming a stable charge transport layer, comprising:
combining PTFE particles, at least one surfactant, and at least one solvent to form a slurry;
separately combining at least one polycarbonate polymeric binder, at least one charge transport material, and at least one solvent to form a base composition;
mixing the slurry and base composition to form a stabilized dispersion, wherein the PTFE particles are uniformly dispersed; and
coating a surface of a photoreceptor with the stabilized dispersion to form a charge transport layer thereon.

12. The method according to claim 11, wherein the base composition further comprises at least one antioxidant.

13. The method according to claim 11, wherein the base composition further comprises a leveling agent.

14. The method according to claim 11, wherein the surfactant is a fluorinated polymeric surfactant.

15. The method according to claim 14, wherein the fluorinated polymeric surfactant is a fluorine graft copolymer.

16. The method according to claim 11, wherein the at least one solvent in the slurry is tetrahydrofuran.

17. The method according to claim 11, wherein the at least one solvent in the base composition is an aromatic hydrocarbon.

18. The method according to claim 17, wherein the aromatic hydrocarbon is toluene.

19. The method according to claim 11, wherein the photoreceptor comprises a charge generating layer and the stabilized dispersion is coated on the charge generating layer.

20. The method according to claim 19, wherein the PTFE particles have a volume average size of less than about 1.5 microns.
